SEQUENCE LISTING (2 sequences)

SEQ ID NO: 1 - protein, 773 aa, Bacillus sp.
AEGNTREDNFKHLLGNDNVKRPSEAGALQLQEVDGQMTLVDQHGEKIQLRGMSTHGLQWFPEILNDNAYKALANDWESNMIRLAMYVGENGYASNPELIKSRVIKGIDLAIENDMYVIVDWHVHAPGDPRDPVYAGAEDFFRDIAALYPNNPHIIYELANEPSSNNNGGAGIPNNEEGWNAVKEYADPIVEMLRDSGNADDNIIIVGSPNWSQRPDLAADNPINDHHTMYTVHFYTGSHAASTESYPPETPNSERGNVMSNTRYALENGVAVFATEWGTSQANGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSADGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEE

SEQ ID NO: 2 - protein, 824 aa, Bacillus sp. KSM-S237
MMLRKKTKQLISSILILVLLLSLFPAALAAEGNTREDNFKHLLGNDNVKRPSEAGALQLQEVDGQMTLVDQHGEKIQLRGMSTHGLQWFPEILNDNAYKALSNDWDSNMIRLAMYVGENGYATNPELIKQRVIDGIELAIENDMYVIVDWHVHAPGDPRDPVYAGAKDFFREIAALYPNNPHIIYELANEPSSNNNGGAGIPNNEEGWKAVKEYADPIVEMLRKSGNADDNIIIVGSPNWSQRPDLAADNPIDDHHTMYTVHFYTGSHAASTESYPSETPNSERGNVMSNTRYALENGVAVFATEWGTSQASGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSANGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEAVKEEKKEAKEEKKAVKNEAKKK

(19) United States
(12) Patent Application Publication
(10) Pub. No.: US 2009/0105109 A1
(43) Pub. Date: Apr. 23, 2009

(54) Detergent compositions

(75) Inventors: Neil Joseph Lant, Newcastle (GB); Steven George Patterson, Tyne & Wear (GB)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company

(21) Appl. No.: 11/825,753

(22) Filed: Jul. 9, 2007

(30) Foreign Application Priority Data
Jul. 7, 2007 (EP) 06116784.7

(51) Int. Cl. C11D 7/42

(52) U.S. Cl. 510/320; 510/392

(57) ABSTRACT

This invention relates to detergent compositions comprising bacterial alkaline enzymes exhibiting endo-beta-1,4-glucanase activity (E.C. 3.2.1.4) and an ethoxylated polymer selected from the group consisting of polyethylene glycol/vinyl acetate graft copolymer; a ethoxylated (and optionally propoxylated) polyethyleneimine; a zwitterionic and ethoxylated polyamidoamine; ethoxylated (and optionally propoxylated) comb polycarboxylate; and mixtures thereof.

### FIELD OF THE INVENTION

This invention relates to detergent compositions comprising a bacterial alkaline enzyme exhibiting endo-beta-1,4-glucanase activity (E.C. 3.2.1.4) and a specific ethoxylated polymer.

### BACKGROUND OF THE INVENTION

Cellulase enzymes have been used in detergent compositions for many years now for their known benefits of depilling, softness and colour care. However, the use of most of cellulases has been limited because of the negative impact that cellulase may have on the tensile strength of the fabrics' fibers by hydrolysing crystalline cellulose. Recently, cellulases with a high specificity towards amorphous cellulose have been developed to exploit the cleaning potential of cellulases while avoiding the negative tensile strength loss. Especially alkaline endo-glucanases have been developed to suit better the use in alkaline detergent conditions.

For example, Novozymes in WO02/099091 discloses a novel enzyme exhibiting endo-beta-glucanase activity (EC 3.2.1.4) endogenous to the strain Bacillus sp., DSM 12648; for use in detergent and textile applications. Novozymes further describes in WO04/053039 detergent compositions comprising an anti-redeposition endo-glucanase and its combination with certain cellulases having increased stability towards anionic surfactant and/or further specific enzymes. Kao's EP 265 832 describes novel alkaline cellulase K, CMCase I and CMCase II obtained by isolation from a culture product of Bacillus sp KSM-635. Kao further describes in EP 1 350 843, alkaline cellulase which acts favourably in an alkaline environment and can be mass produced readily because of having high secretion capacity or having enhanced specific activity.

U.S. Pat. No. 6,235,697 (Colgate) discloses laundry detergent compositions comprising a combination of endo-cellulase, a protease enzyme and a polyacrylate polymer.

We have found that the combination of alkaline bacterial endoglucanases and certain ethoxylated polymers deliver surprising improvements in cleaning and whitening performance. Without wishing to be bound by theory, it is believed that the ethoxylated polymer assists the endoglucanase enzyme in liberating soil from the fabric surface, especially the soils of a greasy or particulate nature. Once soil removal has been effected, the combination of the endoglucanase-modified fabric surface and presence of ethoxylated polymer in the wash liquor, is believed to reduce the tendency of soils to redeposit resulting in good whiteness maintenance.

### SUMMARY OF THE INVENTION

The present invention relates to compositions comprising a bacterial alkaline enzyme exhibiting endo-beta-1,4-glucanase activity (E.C. 3.2.1.4) and an ethoxylated polymer selected from the group consisting of (a) a polyethylene glycol/vinyl acetate graft copolymer (PEG/VA), (b) a ethoxylated (and optionally propoxylated) polyethyleneimine (PEI EO/PO), (c) a zwitterionic and ethoxylated polyamidoamine; (d) ethoxylated (and optionally propoxylated) comb polycarboxylate (EO/PO comb polycarboxylate); and (e) mixtures thereof.

### (a) Polyethylene Glycol/Vinyl Acetate Graft Copolymer (PEG/VA)

The PEG/VA graft polymer of the present invention is a random graft copolymer having a hydrophilic backbone comprising monomers selected from the group consisting of unsaturated C₁₋₆ acids, ethers, alcohols, aldehydes, ketones or esters, sugar units, alkoxy units, maleic anhydride and saturated polyalcohols such as glycerol, and mixtures thereof, and hydrophobic side chains selected from the group comprising a C₄₋₂₅ alkyl group, polypropylene; polybutylene, a vinyl ester of a saturated monocarboxylic acid containing from about 1 to about 6 carbon atoms; a C₁₋₆ alkyl ester of acrylic or methacrylic acid; and a mixture thereof.

### (b) Ethoxylated (and Optionally Propoxylated) Polyethyleneimine (PEI EO/PO)

The PEI EO/PO of the present invention is a modified polyethyleneimine polymer wherein the modified polyethyleneimine polymer comprises a polyethyleneimine backbone of about 300 to about 10000 weight average molecular weight; the modification of the polyethyleneimine backbone is: (1) one or two alkoxylation modifications per nitrogen atom in the polyethyleneimine backbone, the alkoxylation modification consisting of the replacement of a hydrogen atom by a polyalkoxylene chain having an average of about 1 to about 40 alkoxy moieties per modification, wherein the terminal alkoxy moiety of the alkoxylation modification is capped with hydrogen, a C₁-C₄ alkyl or mixtures thereof; (2) a substitution of one C₁-C₄ alkyl moiety and one or two alkoxylation modifications per nitrogen atom in the polyethyleneimine backbone, the alkoxylation modification consisting of the replacement of a hydrogen atom by a polyalkoxylene chain having an average of about 1 to about 40 alkoxy moieties per modification wherein the terminal alkoxy moiety is capped with hydrogen, a C₁-C₄ alkyl or mixtures thereof; or (3) a combination thereof.

### (c) Zwitterionic, Ethoxylated Polyamidoamine

The zwitterionic and ethoxylated polyamidoamine of the present invention is a modified polyaminoamide comprising formula (I)

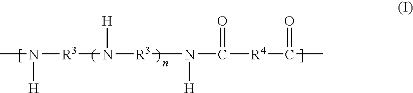

wherein n of formula (I) is an integer from 1 to 500; R³ formula (I) is selected from an C₂-C₈ alkanediyl, preferably 1,2-ethanediyl or 1,3-propane diyl; R⁴ formula (I) is selected from a chemical bond, C₁-C₂₀-alkanediyl, C₁-C₂₀-alkanediyl comprising 1 to 6 heteroatoms selected from the group consisting of oxygen, sulfur, and nitrogen, C₁-C₂₀-alkanediyl comprising 1 to 6 heteroatoms selected from the group consisting of oxygen, sulfur, and nitrogen further comprising one or more hydroxyl groups, a substituted or unsubstituted divalent aromatic radical, and mixtures thereof; wherein formula (I) comprises secondary amino groups of the polymer backbone, the secondary amino groups comprise amino hydrogens, the amino hydrogens are selectively substituted in the modified polyaminoamide such that the modified polyaminoamide comprises partial quaternization of the secondary amino groups by selectively substituting at least one amino hydrogen with at least one alkoxy moiety of formula (II):

—(CH₂—CR¹R²—O—)ₚA (II)

wherein A of formula (II) is selected from a hydrogen or an acidic group, the acidic group being selected from —B¹—PO(OH)₂, —B¹—S(O)₂OH and —B²—COOH; such that B¹ of formula (II) is a single bond or C₁-C₆-alkanediyl; and B² of formula (II) is C₁-C₆-alkanediyl; R¹ of formula (II) is independently selected from hydrogen, C₁-C₁₂-alkyl, C₂-C₈-alkenyl, C₆-C₁₆-aryl or C₆-C₁₆-aryl-C₁-C₄-alkyl; R² of formula (II) is independently selected from hydrogen or methyl; and p of formula (II) is an integer comprising a number average of at least 10;
With the remainder of the amino hydrogens of the secondary amino groups being selected from the group comprising electron pairs, hydrogen, C₁-C₆-alkyl, C₆-C₁₆-aryl-C₁-C₄-alkyl and formula (III) Alk-O-A, wherein
A of formula (III) is hydrogen or an acidic group, the acidic group being selected from —B¹—PO(OH)₂, —B¹—S(O)₂OH and —B²—COOH; such that B¹ of formula (III) is selected from a single bond or a C₁-C₆-alkanediyl; and B² of formula (III) is selected from a C₁-C₆-alkanediyl, and Alk of formula (III) is C₂-C₆-alkane-1,2-diyl;
the secondary amino groups of formula (I) are further selected to comprise at least one alkylating moiety of formula (IV):

-RX (IV)

Wherein R of formula (IV) is selected from the group consisting of: C₁-C₆-alkyl, C₆-C₁₆-aryl-C₁-C₄-alkyl and formula (III) Alk-O-A, formula (II) —(CH₂—CR¹R²—O—)ₚA; and X of formula (IV) is a leaving group selected from halogen, an alkyl-halogen, a sulphate, an alkyl sulphonate, an aryl sulphonate, an alkyl sulphate, and mixtures thereof.

### (d) Ethoxylated (and Optionally Propoxylated) Comb Polycarboxylate (EO/PO Comb Polycarboxylate)

The EO/PO comb polycarboxylate polymer of the present invention is a non-hydrophobically modified, acrylic/polyether comb-branched copolymer wherein the polyether portion comprises moieties derived from at least 2 constituents selected from the group consisting of ethylene oxide, propylene oxide and butylenes oxide.

### SEQUENCE LISTINGS

SEQ ID NO: 1 shows the amino acid sequence of an endoglucanase from Bacillus sp. AA349 SEQ ID NO: 2 shows the amino acid sequence of an endoglucanase from Bacillus sp KSM-S237

### DETAILED DESCRIPTION OF THE INVENTION

### Definitions

As used herein, the term “cleaning composition” includes, unless otherwise indicated, granular or powder-form all-purpose or “heavy-duty” washing agents, especially laundry detergents; liquid, gel or paste-form all-purpose washing agents, especially the so-called heavy-duty liquid types; liquid fine-fabric detergents; as well as cleaning auxiliaries such as bleach additives and “stain-stick” or pre-treat types.

### Compositions

The composition of the present invention may contain from 0.1% to 10%, from 0.2% to 3%, or even from 0.3% to 2% by weight of one or more ethoxylated polymer(s) and from 0.00005% to 0.15%, from 0.0002% to 0.02%, or even from 0.0005% to 0.01% by weight of pure enzyme, of one or more endoglucanase(s). The balance of any aspects of the aforementioned cleaning compositions is made up of one or more adjunct materials.

### Suitable Endoglucanase

The endoglucanase to be incorporated into the detergent composition of the present invention is one or more bacterial alkaline enzyme(s) exhibiting endo-beta-1,4-glucanase activity (E.C. 3.2.1.4). As used herein the term “alkaline endoglucanase”, shall mean an endoglucanase having an pH optimum above 7 and retaining greater than 70% of its optimal activity at pH 10. Preferably, the endoglucanase is a bacterial polypeptide endogenous to a member of the genus Bacillus.

More preferably, the alkaline enzyme exhibiting endo-beta-1,4-glucanase activity (E.C. 3.2.1.4), is a polypeptide containing (i) at least one family 17 carbohydrate binding module (Family 17 CBM) and/or (ii) at least one family 28 carbohydrate binding module (Family 28 CBM). Please refer for example to: Current Opinion in Structural Biology, 2001, 593-600 by Y. Bourne and B. Henrissat in their article entitled: “Glycoside hydrolases and glycosyltransferases: families and functional modules” for the definition and classification of CBMs. Please refer further to Biochemical Journal, 2002, v361, 35-40 by A. B. Boraston et al in their article entitled: “Identification and glucan-binding properties of a new carbohydrate-binding module family” for the properties of the family 17 and 28 CBM's.

In a more preferred embodiment, said enzyme comprises a polypeptide (or variant thereof) endogenous to one of the following Bacillus species.

| Bacillus sp. | As described in: |
|---|---|
| AA349 (DSM 12648) | WO 2002/099091A (Novozymes) p2, line 25 |
| | WO 2004/053039A (Novozymes) p3, line19 |
| KSM S237 | EP 1350843A (Kao) p3, line 18 |
| 1139 | EP 1350843A (Kao) p3, line 22 |
| KSM 64 | EP 1350843A (Kao) p3, line 24 |
| KSM N131 | EP 1350843A (Kao) p3, line 25 |
| KSM 635, FERM BP 1485 | EP 265 832A (Kao) p7, line 45 |
| KSM 534, FERM BP 1508 | EP 0271044 A (Kao) p9, line 21 |
| KSM 539, FERM BP 1509 | EP 0271044 A (Kao) p9, line 22 |
| KSM 577, FERM BP 1510 | EP 0271044 A (Kao) p9, line 22 |
| KSM 521, FERM BP 1507 | EP 0271044 A (Kao) p9, line 19 |
| KSM 580, FERM BP 1511 | EP 0271044 A (Kao) p9, line 20 |
| KSM 588, FERM BP 1513 | EP 0271044 A (Kao) p9, line 23 |
| KSM 597, FERM BP 1514 | EP 0271044 A (Kao) p9, line 24 |
| KSM 522, FERM BP 1512 | EP 0271044 A (Kao) p9, line 20 |
| KSM 3445, FERM | EP 0271044 A (Kao) p10, line 3 |
| BP 1506 | |
| KSM 425. FERM BP 1505 | EP 0271044 A (Kao) p10, line 3 |

Suitable endoglucanases for the compositions of the present invention are:

1) An enzyme exhibiting endo-beta-1,4-glucanase activity (E.C. 3.2.1.4), which has a sequence of at least 90%, preferably 94%, more preferably 97% and even more preferably 99%, 100% identity to the amino acid sequence of position 1 to position 773 of SEQ ID NO:1 (Corresponding to SEQ ID NO:2 in WO02/099091); or a fragment thereof that has endo-beta-1,4-glucanase activity, when identity is determined by GAP provided in the GCG program using a GAP creation penalty of 3.0 and GAP extension penalty of 0.1. The enzyme and the corresponding method of production is described extensively in patent application WO02/099091 published by Novozymes A/S on Dec. 12, 2002. Please refer to the detailed description pages 4 to 17 and to the examples page 20 to page 26. One of such enzyme is commercially available under the tradename Celluclean™ by Novozymes A/S.
GCG refers to the sequence analysis software package provided by Accelrys, San Diego, Calif., USA. This incorporates a program called GAP which uses the algorithm of Needleman and Wunsch to find the alignment of two complete sequences that maximises the number of matches and minimises the number of gaps.
2) Also suitable are the alkaline endoglucanase enzymes described in EP 1350 843A published by Kao corporation on Oct. 8, 2003. Please refer to the detailed description [0011] to [0039] and examples 1 to 4 [0067] to [0077] for a detailed description of the enzymes and its production. The alkaline cellulase variants are obtained by substituting the amino acid residue of a cellulase having an amino acid sequence exhibiting at least 90%, preferably 95%, more preferably 98% and even 100% identity with the amino acid sequence represented by SEQ. ID NO:2 (Corresponding to SEQ. ID NO:1 in EP 1 350 843 on pages 11-13) at (a) position 10, (b) position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564, or (p) position 608 in SEQ ID NO:2 or at a position corresponding thereto with another amino acid residue

Examples of the “alkaline cellulase having the amino acid sequence represented by SEQ. ID NO:2” include Egl-237 [derived from Bacillus sp. strain KSM-S237 (FERM BP-7875), Hakamada, et al., Biosci. Biotechnol. Biochem., 64, 2281-2289, 2000]. Examples of the “alkaline cellulase having an amino acid sequence exhibiting at least 90% homology with the amino acid sequence represented by SEQ. ID NO:2” include alkaline cellulases having an amino acid sequence exhibiting preferably at least 95% homology, more preferably at least 98% homology, with the amino acid sequence represented by SEQ. ID NO:2. Specific examples include alkaline cellulase derived from Bacillus sp. strain 1139 (Egl-1139) (Fukumori, et al., J. Gen. Microbiol., 132, 2329-2335) (91.4% homology), alkaline cellulases derived from Bacillus sp. strain KSM-64 (Egl-64) (Sumitomo, et al., Biosci. Biotechnol. Biochem., 56, 872-877, 1992) (homology: 91.9%), and cellulase derived from Bacillus sp. strain KSM-N131 (Egl-N131b) (Japanese Patent Application No. 2000-47237) (homology: 95.0%).

The amino acid is preferably substituted by: glutamine, alanine, proline or methionine, especially glutamine is preferred at position (a), asparagine or arginine, especially asparagine is preferred at position (b), proline is preferred at position (c), histidine is preferred at position (d), alanine, threonine or tyrosine, especially alanine is preferred at position (e), histidine, methionine, valine, threonine or alanine, especially histidine is preferred at position (f), isoleucine, leucine, serine or valine, especially isoleucine is preferred at position (g), alanine, phenylalanine, valine, serine, aspartic acid, glutamic acid, leucine, isoleucine, tyrosine, threonine, methionine or glycine, especially alanine, phenylalanine or serine is preferred at position (h), isoleucine, leucine, proline or valine, especially isoleucine is preferred at position (i), alanine, serine, glycine or valine, especially alanine is preferred at position (j), threonine, leucine, phenylalanine or arginine, especially threonine is preferred at position (k), leucine, alanine or serine, especially leucine is preferred at position (l), alanine, aspartic acid, glycine or lysine, especially alanine is preferred at position (m), methionine is preferred at position (n), valine, threonine or leucine, especially valine is preferred at position (o) and isoleucine or arginine, especially isoleucine is preferred at position (p).

The “amino acid residue at a position corresponding thereto” can be identified by comparing amino acid sequences by using known algorithm, for example, that of Lipman-Pearson's method, and giving a maximum similarity score to the multiple regions of simirality in the amino acid sequence of each alkaline cellulase. The position of the homologous amino acid residue in the sequence of each cellulase can be determined, irrespective of insertion or depletion existing in the amino acid sequence, by aligning the amino acid sequence of the cellulase in such manner (FIG. 1 of EP 1 350 843). It is presumed that the homologous position exists at the three-dimensionally same position and it brings about similar effects with regard to a specific function of the target cellulase.

With regard to another alkaline cellulase having an amino acid sequence exhibiting at least 90% homology with SEQ. ID NO:2, specific examples of the positions corresponding to (a) position 10, (b), position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564 and (p) position 608 of the alkaline cellulase (Egl-237) represented by SEQ. ID NO: 2 and amino acid residues at these positions will be shown below:

| | Egl-237 | Egl-1139 | Egl-64 | Egl-N131b |
|---|---|---|---|---|
| (a) | 10Leu | 10Leu | 10Leu | 10Leu |
| (b) | 16Ile | 16Ile | 16Ile | Nothing corresponding thereto |
| (c) | 22Ser | 22Ser | 22Ser | Nothing corresponding thereto |
| (d) | 33Asn | 33Asn | 33Asn | 19Asn |
| (e) | 39Phe | 39Phe | 39Phe | 25Phe |
| (f) | 76Ile | 76Ile | 76Ile | 62Ile |
| (g) | 109Met | 109Met | 109Met | 95Met |
| (h) | 242Gln | 242Gln | 242Gln | 228Gln |
| (i) | 263Phe | 263Phe | 263Phe | 249Phe |
| (j) | 308Thr | 308Thr | 308Thr | 294Thr |
| (k) | 462Asn | 461Asn | 461Asn | 448Asn |
| (l) | 466Lys | 465Lys | 465Lys | 452Lys |
| (m) | 468Val | 467Val | 467Val | 454Val |
| (n) | 552Ile | 550Ile | 550Ile | 538Ile |
| (o) | 564Ile | 562Ile | 562Ile | 550Ile |
| (p) | 608Ser | 606Ser | 606Ser | 594Ser |

3) Also suitable is the alkaline cellulase K described in EP 265 832A published by Kao on May 4, 1988. Please refer to the description page 4, line 35 to page 12, line 22 and examples 1 and 2 on page 19 for a detailed description of the enzyme and its production. The alkaline cellulase K has the following physical and chemical properties:
(1) Activity: Having a Cx enzymatic activity of acting on carboxymethyl cellulose along with a weak C₁ enzymatic activity and a weak beta-glucoxidase activity;
(2) Specificity on Substrates: Acting on carboxymethyl cellulose (CMC), crystalline cellulose, Avicell, cellobiose, and p-nitrophenyl cellobioside (PNPC);
(3) Having a working pH in the range of 4 to 12 and an optimum pH in the range of 9 to 10;
(4) Having stable pH values of 4.5 to 10.5 and 6.8 to 10 when allowed to stand at 40° C. for 10 minutes and 30 minutes, respectively;
(5) Working in a wide temperature range of from 10 to 65° C. with an optimum temperature being recognized at about 40° C.;
(6) Influences of chelating agents: The activity not impeded with ethylenediamine tetraacetic acid (EDTA), ethyleneglycol-bis-(β-aminoethylether) N,N,N′,N″-tetraacetic acid (EGTA), N,N-bis(carboxymethyl)glycine (nitrilotriacetic acid) (NTA), sodium tripolyphosphate (STPP) and zeolite;
(7) Influences of surface active agents: Undergoing little inhibition of activity by means of surface active agents such as sodium linear alkylbenzenesulfonates (LAS), sodium alkylsulfates (AS), sodium polyoxyethylene alkylsulfates (ES), sodium alpha-olefinsulfonates (AOS), sodium alpha-sulfonated aliphatic acid esters (alpha-SFE), sodium alkylsulfonates (SAS), polyoxyethylene secondary alkyl ethers, fatty acid salts (sodium salts), and dimethyldialkylammonium chloride;
(8) Having a strong resistance to proteinases; and
(9) Molecular weight (determined by gel chromatography): Having a maximum peak at 180,000±10,000.
Preferably such enzyme is obtained by isolation from a culture product of Bacillus sp KSM-635.

Cellulase K is commercially available by the Kao Corporation: e.g. the cellulase preparation Eg-X known as KAC® being a mixture of E-H and E-L both from Bacillus sp. KSM-635 bacterium. Cellulases E-H and E-L have been described in S. Ito, Extremophiles, 1997, vl, 61-66 and in S. Ito et al, Agric Biol Chem, 1989, v53, 1275-1278.

4) The alkaline bacterial endoglucanases described in EP 271 004A published by Kao on Jun. 15, 1988 are also suitable for the purpose of the present invention. Please refer to the description page 9, line 15 to page 23, line 17 and page 31, line 1 to page 33, line 17 for a detailed description of the enzymes and its production. Those are:
Alkaline Cellulase K-534 from KSM 534, FERM BP 1508,
Alkaline Cellulase K-539 from KSM 539, FERM BP 1509,
Alkaline Cellulase K-577 from KSM 577, FERM BP 1510,
Alkaline Cellulase K-521 from KSM 521, FERM BP 1507,
Alkaline Cellulase K-580 from KSM 580, FERM BP 1511,
Alkaline Cellulase K-588 from KSM 588, FERM BP 1513,
Alkaline Cellulase K-597 from KSM 597, FERM BP 1514,
Alkaline Cellulase K-522 from KSM 522, FERM BP 1512,
Alkaline Cellulase E-II from KSM 522, FERM BP 1512,
Alkaline Cellulase E-III from KSM 522, FERM BP 1512.
Alkaline Cellulase K-344 from KSM 344, FERM BP 1506, and
Alkaline Cellulase K-425 from KSM 425, FERM BP 1505.
5) Finally, the alkaline endoglucanases derived from Bacillus species KSM-N described in JP2005287441A, published by Kao on the Oct. 20, 2005, are also suitable for the purpose of the present invention. Please refer to the description page 4, line 39 to page 10, line 14 for a detailed description of the enzymes and its production. Examples of such alkaline endoglucanases are:
Alkaline Cellulase Egl-546H from Bacillus sp. KSM-N546
Alkaline Cellulase Egl-115 from Bacillus sp. KSM-N115
Alkaline Cellulase Egl-145 from Bacillus sp. KSM-N145
Alkaline Cellulase Egl-659 from Bacillus sp. KSM-N659
Alkaline Cellulase Egl-640 from Bacillus sp. KSM-N440
Also encompassed in the present invention are variants of the above described enzymes obtained by various techniques known by persons skilled in the art such as directed evolution.

### (a) PEG/VA Graft Polymer

The PEG/VA graft polymer of the present invention is a random graft copolymer having a hydrophilic backbone and hydrophobic side chains. Typically, the hydrophilic backbone constitutes less than about 50%, or from about 50% to about 2%, or from about 45% to about 5%, or from about 40% to about 10% by weight of the polymer.

The backbone of the polymer preferably comprises monomers selected from the group consisting of unsaturated C₁₋₆ acids, ethers, alcohols, aldehydes, ketones or esters, sugar units, alkoxy units, maleic anhydride and saturated polyalcohols such as glycerol, and mixtures thereof. In an embodiment herein the hydrophilic backbone comprises acrylic acid, methacrylic acid, maleic acid, vinyl acetic acid, glucosides, alkylene oxide, glycerol, or mixtures thereof. In another embodiment herein the polymer comprises a polyalkylene oxide backbone comprising ethylene oxide, propylene oxide and/or butylene oxide. In an embodiment herein the polyalkylene oxide backbone comprises more than about 80%, or from about 80% to about 100%, or from about 90% to about 100% or from about 95% to about 100% by weight ethylene oxide. The weight average molecular weight (Mw) of the polyalkylene oxide backbone is typically from about 400 g/mol to 40,000 g/mol, or from about 1,000 g/mol to about 18,000 g/mol, or from about 3,000 g/mol to about 13,500 g/mol, or from about 4,000 g/mol to about 9,000 g/mol. The polyalkylene oxide backbone may be either linear or branched in structure. The polyalkylene backbone may be extended by condensation with suitable connecting molecules such as, but not limited to, dicarboxylic acids and/or diisocianates.

The backbone contains a plurality of hydrophobic side chains attached thereto. Typical hydrophobic side chains useful in the polymer herein may be selected from a C₄₋₂₅ alkyl group; polypropylene; polybutylene, a vinyl ester of a saturated monocarboxylic acid containing from about 1 to about 6 carbon atoms; a C₁₋₆ alkyl ester of acrylic or methacrylic acid; and a mixture thereof. In an embodiment herein the hydrophobic side chains comprise, by weight of the hydrophobic side chains, at least about 50% vinyl acetate, or from about 50% to about 100% vinyl acetate, or from about 70% to about 100% vinyl acetate, or from about 90% to about 100% vinyl acetate. In another embodiment herein the hydrophobic side chains comprise, by weight of the hydrophobic side chains, from about 70% to about 99.9% vinyl acetate, or from about 90% to about 99% vinyl acetate. However, it has also been found that butyl acrylate side chains may also be useful herein; therefore in an embodiment herein the hydrophobic side chains comprise, by weight of the hydrophobic side chains, from about 0.1% to about 10% butyl acrylate, or from about 1% to about 7% butyl acrylate, or from about 2% to about 5% butyl acrylate. The hydrophobic side chains may also comprise a modifying monomer such as, but not limited to, styrene, N-vinylpyrrolidone, acrylic acid, methacrylic acid, maleic acid, acrylamide, vinyl acetic acid and/or vinyl formamide. In an embodiment herein, the hydrophobic side chains comprise, by weight of the hydrophobic side chains, from about 0.1% to about 5% styrene, or from about 0.5% to about 4% styrene, or from about 1% to about 3% styrene. In an embodiment herein, the hydrophobic side chains comprise, by weight of the hydrophobic side chains, from about 0.1% to about 10% N-vinylpyrrolidone, or from about 0.5% to 6% N-vinylpyrrolidone, or from about 1% to about 3% N-vinylpyrrolidone.

In an embodiment herein the polymer is a random graft polymer obtained by grafting (a) polyethylene oxide; (b) a vinyl ester derived from acetic acid and/or propionic acid; an alkyl ester of acrylic or methacylic acid in which the alkyl group contains from 1 to 4 carbon atoms, and mixtures thereof; and (c) modifying monomers such as N-vinylpyrrolidone and/or styrene. The polymer herein may have the general formula:

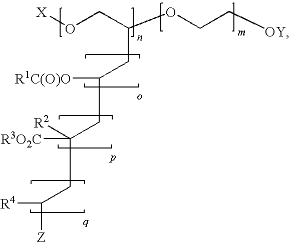

where X and Y are capping units independently selected from H or a C₁₋₆ alkyl; Z is a capping unit selected from H or a C-radical moiety (i.e., a carbon-containing fragment derived from the radical initiator attached to the growing chain as result of a recombination process); each R¹ is independently selected from methyl and ethyl; each R² is independently selected from H and methyl; each R³ is independently a C₁₋₄ alkyl; and each R⁴ is independently selected from pyrrolidone and phenyl groups. The weight average molecular weight of the polyethylene oxide backbone is typically from about 1,000 g/mol to about 18,000 g/mol, or from about 3,000 g/mol to about 13,500 g/mol, or from about 4,000 g/mol to about 9,000 g/mol. The value of m, n, o, p and q is selected such that the pendant groups comprise, by weight of the polymer at least 50%, or from about 50% to about 98%, or from about 55% to about 95%, or from about 60% to about 90%. The polymer useful herein typically has a weight average molecular weight of from about 1,000 to about 100,000 g/mol, or from about 2,500 g/mol to about 45,000 g/mol, or from about 7,500 g/mol to about 33,800 g/mol, or from about 10,000 g/mol to about 22,500 g/mol.

Preferably the polymer is manufactured by a radical grafting polymerization reaction carried out with a suitable radical initiator at temperatures below about 100° C., or from about 100° C. to about 60° C., or from about 90° C. to about 65° C., or from about 80° C. to about 70° C. While polymers have previously been disclosed which have grafting temperatures above about 100° C., it is believed that the lower temperatures herein result in a significantly different primary structure for the polymer, due to the lower kinetics. While it is recognized that these are typically “random graft polymers”, without intending to be limited by theory, it is believed that the lower grafting temperature increases the overall size of each individual grafted chain and that the grafted chains are more spaced across the polymer. Thus, it is believed that polymers formed at the lower grafting temperatures are overall more hydrophilic than polymers formed at the higher grafting temperatures. Thus, the polymers formed at the lower grafting temperatures have comparatively higher cloud points in water.

In an embodiment herein, the polymer further contains a plurality of hydrolysable moieties, such as but not limited to ester- or amide-containing moieties. In such a case, the polymer may be partially or fully hydrolyzed. The degree of hydrolysis of the polymer is defined as the mol % of hydrolysable moieties which have been hydrolyzed into the corresponding fragments. Typically, the degree of hydrolysis of the polymer will be no greater than about 75 mol %, or from about 0 mol % to about 75 mol %, or from about 0 mol % to about 60 mol %, or from about 0 mol % to about 40 mol %. In an embodiment herein, the degree of hydrolysis of the polymer is from about 30 mol % to about 45 mol % or from about 0 mol % to about 10 mol

### (b) Ethoxylated (and Optionally Propoxylated) Polyethyleneimine PEI EO/PO

The modified polyethyleneimine polymer of the present composition has a polyethyleneimine backbone having a molecular weight from about 300 to about 10000 weight average molecular weight, preferably from about 400 to about 7500 weight average molecular weight, preferably about 500 to about 1900 weight average molecular weight and preferably from about 3000 to 6000 weight average molecular weight.

The modification of the polyethyleneimine backbone includes: (1) one or two alkoxylation modifications per nitrogen atom, dependent on whether the modification occurs at a internal nitrogen atom or at an terminal nitrogen atom, in the polyethyleneimine backbone, the alkoxylation modification consisting of the replacement of a hydrogen atom on by a polyalkoxylene chain having an average of about 1 to about 40 alkoxy moieties per modification, wherein the terminal alkoxy moiety of the alkoxylation modification is capped with hydrogen, a C₁-C₄ alkyl or mixtures thereof; (2) a substitution of one C₁-C₄ alkyl moiety and one or two alkoxylation modifications per nitrogen atom, dependent on whether the substitution occurs at a internal nitrogen atom or at an terminal nitrogen atom, in the polyethyleneimine backbone, the alkoxylation modification consisting of the replacement of a hydrogen atom by a polyalkoxylene chain having an average of about 1 to about 40 alkoxy moieties per modification wherein the terminal alkoxy moiety is capped with hydrogen, a C₁-C₄ alkyl or mixtures thereof; or (3) a combination thereof.

For example, but not limited to, below is shown possible modifications to terminal nitrogen atoms in the polyethyleneimine backbone where R represents an ethylene spacer and E represents a C₁-C₄ alkyl moiety and X_ represents a suitable water soluble counterion.

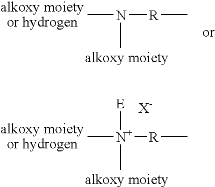

Also, for example, but not limited to, below is shown possible modifications to internal nitrogen atoms in the polyethyleneimine backbone where R represents an ethylene spacer and E represents a C₁-C₄ alkyl moiety and X— represents a suitable water soluble counterion.

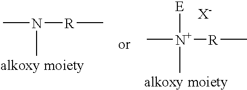

The alkoxylation modification of the polyethyleneimine backbone consists of the replacement of a hydrogen atom by a polyalkoxylene chain having an average of about 1 to about 40 alkoxy moieties, preferably from about 5 to about 20 alkoxy moieties. The alkoxy moieties are selected from ethoxy (EO), 1,2-propoxy (1,2-PO), 1,3-propoxy (1,3-PO), butoxy (BO), and combinations thereof. Preferably, the polyalkoxylene chain is selected from ethoxy moieties and ethoxy/propoxy block moieties. More preferably, the polyalkoxylene chain is ethoxy moieties in an average degree of from about 5 to about 15 and the polyalkoxylene chain is ethoxy/propoxy block moieties having an average degree of ethoxylation from about 5 to about 15 and an average degree of propoxylation from about 1 to about 16. Most preferable the polyalkoxylene chain is the ethoxy/propoxy block moieties wherein the propoxy moiety block is the terminal alkoxy moiety block.

The modification may result in permanent quaternization of the polyethyleneimine backbone nitrogen atoms. The degree of permanent quaternization may be from 0% to about 30% of the polyethyleneimine backbone nitrogen atoms. It is preferred to have less than 30% of the polyethyleneimine backbone nitrogen atoms permanently quaternized.

A preferred modified polyethyleneimine has the general structure of formula (I):

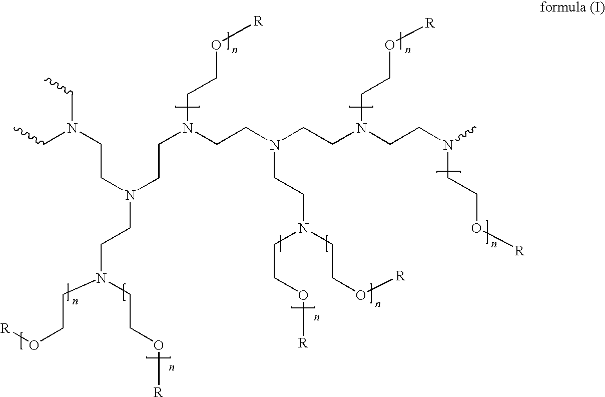

wherein the polyethyleneimine backbone has a weight average molecular weight of 5000, n of formula (I) has an average of 7 and R of formula (I) is selected from hydrogen, a C₁-C₄ alkyl and mixtures thereof.

Another preferred polyethyleneimine has the general structure of formula (II):

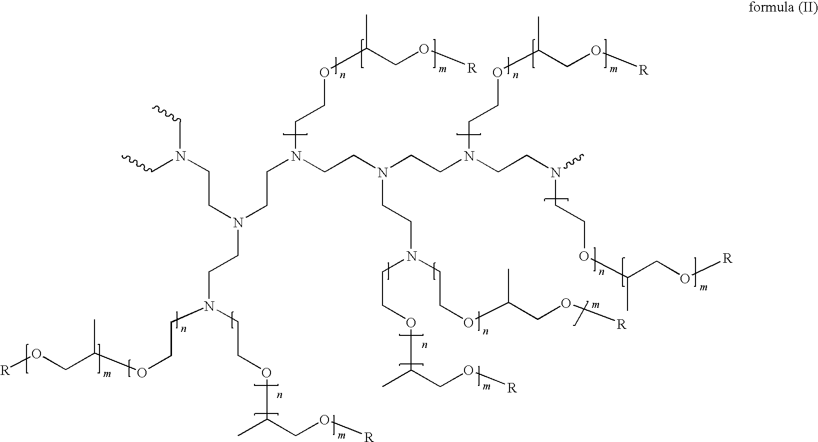

wherein the polyethyleneimine backbone has a weight average molecular weight of 5000, n of formula (II) has an average of 10, m of formula (II) has an average of 7 and R of formula (II) is selected from hydrogen, a C₁-C₄ alkyl and mixtures thereof. The degree of permanent quaternization of formula (II) may be from 0% to about 22% of the polyethyleneimine backbone nitrogen atoms.

Yet another preferred polyethyleneimine has the same general structure of formula (II) where the polyethyleneimine backbone has a weight average molecular weight of 600, n of formula (II) has an average of 10, m of formula (II) has an average of 7 and R of formula (II) is selected from hydrogen, a C₁-C₄ alkyl and mixtures thereof. The degree of permanent quaternization of formula (II) may be from 0% to about 22% of the polyethyleneimine backbone nitrogen atoms.

These polyethyleneimines can be prepared, for example, by polymerizing ethyleneimine in the presence of a catalyst such as carbon dioxide, sodium bisulfite, sulfuric acid, hydrogen peroxide, hydrochloric acid, acetic acid, and the like. Specific methods for preparing these polyamine backbones are disclosed in U.S. Pat. No. 2,182,306, Ulrich et al., issued Dec. 5, 1939; U.S. Pat. No. 3,033,746, Mayle et al., issued May 8, 1962; U.S. Pat. No. 2,208,095, Esselmann et al., issued Jul. 16, 1940; U.S. Pat. No. 2,806,839, Crowther, issued Sep. 17, 1957; and U.S. Pat. No. 2,553,696, Wilson, issued May 21, 1951. Please refer to examples 1 to 4 in the co-pending patent application from The Procter & Gamble Company filed on Apr. 15, 2005 under the U.S. Ser No. US60/671,588 illustrating the preparation of 4 different polyethyleneimines.

### (c) Zwitterionic and Ethoxylated Polyamidoamine Polymers

The zwitterionic and ethoxylated polyamidoamine of the present invention is a modified polyaminoamide comprising formula (I)

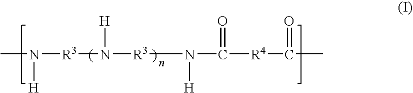

wherein n of formula (I) is an integer from 1 to 500; R³ formula (I) is selected from an C₂-C₈ alkanediyl, preferably 1,2-ethanediyl or 1,3-propane diyl; R⁴ formula (I) is selected from a chemical bond, C₁-C₂₀-alkanediyl, C₁-C₂₀-alkanediyl comprising 1 to 6 heteroatoms selected from the group consisting of oxygen, sulfur, and nitrogen, C₁-C₂₀-alkanediyl comprising 1 to 6 heteroatoms selected from the group consisting of oxygen, sulfur, and nitrogen further comprising one or more hydroxyl groups, a substituted or unsubstituted divalent aromatic radical, and mixtures thereof; wherein formula (I) comprises secondary amino groups of the polymer backbone, the secondary amino groups comprise amino hydrogens, the amino hydrogens are selectively substituted in the modified polyaminoamide such that the modified polyaminoamide comprises partial quaternization of the secondary amino groups by selectively substituting at least one amino hydrogen with at least one alkoxy moiety of formula (II):

—(CH₂—CR¹R²—O—)ₚA (II)

wherein A of formula (II) is selected from a hydrogen or an acidic group, the acidic group being selected from —B¹—PO(OH)₂, —B¹—S(O)₂OH and —B²—COOH; such that B¹ of formula (II) is a single bond or C₁-C₆-alkanediyl; and B² of formula (II) is C₁-C₆-alkanediyl; R¹ of formula (II) is independently selected from hydrogen, C₁-C₁₂-alkyl, C₂-C₈-alkenyl, C₆-C₁₆-aryl or C₆-C₁₆-aryl-C₁-C₄-alkyl; R² of formula (II) is independently selected from hydrogen or methyl; and p of formula (II) is an integer comprising a number average of at least 10;
With the remainder of the amino hydrogens of the secondary amino groups being selected from the group comprising electron pairs, hydrogen, C₁-C₆-alkyl, C₆-C₁₆-aryl-C₁-C₄-alkyl and formula (III) Alk-O-A, wherein
A of formula (III) is hydrogen or an acidic group, the acidic group being selected from —B¹—PO(OH)₂, —B¹—S(O)₂OH and —B²—COOH; such that B¹ of formula (III) is selected from a single bond or a C₁-C₆-alkanediyl; and B² of formula (III) is selected from a C₁-C₆-alkanediyl, and Alk of formula (III) is C₂-C₆-alkane-1,2-diyl;
the secondary amino groups of formula (I) are further selected to comprise at least one alkylating moiety of formula (IV):

-RX (IV)

Wherein R of formula (IV) is selected from the group consisting of: C₁-C₆-alkyl, C₆-C₁₆-aryl-C₁-C₄-alkyl and formula (III) Alk-O-A, formula (II) —(CH₂—CR¹R²—O—)ₚA; and X of formula (IV) is a leaving group selected from halogen, an alkyl-halogen, a sulphate, an alkyl sulphonate, an aryl sulphonate, an alkyl sulphate, and mixtures thereof.

The zwitterionic and ethoxylated polyamidoamine of the present invention are described in details and their preparation methods can be found on pages 3 to 14 of WO2005/093030 published by The Procter & Gamble Company on Oct. 6, 2005.

The modified polyaminoamide can further comprises aliphatic, aromatic or cycloaliphatic diamines to give the general formula (VII):

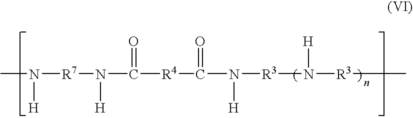

wherein R³, R⁴, and n of formula (VI) are the same as formula (I); R⁷ of formula (VI) is a bivalent organic radical carrying from 1 to 20 carbon atoms, C₁-C₂₀-alkanediyl comprising 1 to 6 heteroatoms selected from the group consisting of oxygen, sulfur, and nitrogen, C₁-C₂₀-alkanediyl, C₁-C₂₀-alkanediyl comprising 1 to 6 heteroatoms selected from the group consisting of oxygen, sulfur, and nitrogen further comprising one or more hydroxyl groups, a substituted or unsubstituted divalent aromatic radical, and mixtures thereof.

The modified polyaminoamide can further comprise an esterification moiety for the alkoxy moiety, the alkylating moiety, and mixtures thereof, provided a hydroxyl group is present in the alkoxy moiety and the alkylating moiety. Preferably, the esterification moiety is selected from chlorosulfonic acid, sulfur trioxide, amidosulfonic acid, polyphosphate, phosphoryl chloride, phosphorpentoxide, and mixtures thereof.

The polyaminoamide can comprise primary amino groups of the polymer backbone, preferably the primary amino groups comprise amino hydrogens, the amino hydrogens are modified by comprising at least one alkoxy moiety of formula (II), with the remainder of the amino hydrogens of the secondary amino groups being further modified from the group consisting of electron pairs, hydrogen, C₁-C₆-alkyl, C₆-C₁₆-aryl-C₁-C₄-alkyl and formula (III) Alk-O-A, and the primary amino groups are further modified by comprising at least one alkylating moiety of formula (II). Such modified polyaminoamide can further comprise an esterification moiety for the alkoxy moiety, the alkylating moiety, and mixtures thereof when a hydroxyl group is present in the alkoxy moiety and the alkylating moiety. The etherifying moieties can be selected from the formula (XV) L-B³-A′, wherein A′ of formula (XV) is selected from —COOH, —SO₃H, and —PO(OH)₂, B³ of formula (XV) is selected from C₁-C₆-alkandiyl; and L of formula (XV) is a leaving group that can be replaced by nucleophiles.

In a preferred embodiment, the detergent composition comprises a modified polyaminoamide of formula (IX):

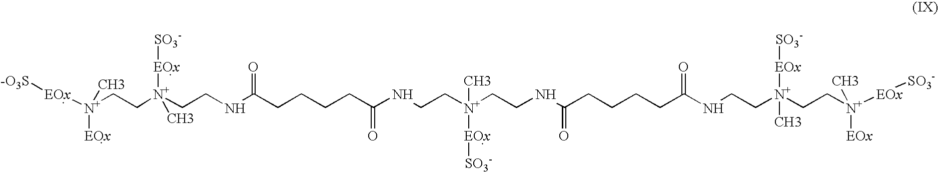

wherein x of formula (IX) is from 10 to 200, preferably from about 15 to about 150, most preferably from about 21 to about 100. Most preferably the number average of x of formula (IX) ranges from 15 to 70, especially 21 to 50. EO in formula (IX) represents ethoxy moieties.

In another preferred embodiment, the detergent composition comprises a modified polyaminoamide of formula (X):

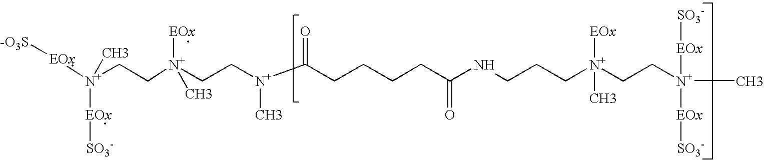

wherein x of formula (X) is from 10 to 200, preferably from about 15 to about 150, most preferably from about 21 to about 100. Most preferably the number average of x of formula (X) ranges from 15 to 70, especially 21 to 50. EO in formula (X) represents ethoxy moieties. The ratio of dicarboxylic acid:polyalkylenepolyamines in formula (X) is 4:5 and 35:36.

### (d) EO/PO Comb Polycarboxylate

The EO/PO comb polycarboxylate of the present invention comprises a non-hydrophobically modified, acrylic/polyether comb-branched copolymer wherein the polyether portion comprises moieties derived from at least two constituents selected from the group consisting of ethylene oxide, propylene oxide and butylene oxide. By nonhydrophobically modified, it is meant that the polyether chain does not bear any hydrophobic end caps, i.e., a hydrocarbon having more than four carbon atoms, such as 2-ethylhexyl, lauryl, nonylphenyl, and the like.

The non-hydrophobically modified, acrylic/polyether comb-branched copolymer preferably has a molecular weight of 400 grams per mole to about 500,000 grams per mole, more preferably between about 600 grams per mole to about 400,000 grains per mole, and most preferably between about 1,000 grams per mole to about 100,000 grams per mole. The copolymer preferably has a mole ratio of acrylic monomer units to polyether units of about 1/99 to about 99/1, more preferably from about 1/1 to about 20/1, and most preferably from about 4/1 to about 20/1.

The comb-branched copolymer can be made by any suitable process for copolymerizing acrylic units with polyether units, as long as the resulting copolymer is non-hydrophobically modified and comprises polyether units containing moieties derived from at least two constituents selected from the group consisting of ethylene oxide, propylene oxide and butylene oxide. Preferably, the copolymer is formed by reacting a polyether polymer or macromonomer with an acrylic monomer or polyacrylic acid polymer. The process may be continuous, batch, or semi-batch. Following the copolymerization process, any relatively volatile unreacted monomers are generally stripped from the product.

More preferably, the comb-branched copolymer is made according to a process selected from the group consisting of (i) copolymerizing an unsaturated macromonomer with at least one ethylenically unsaturated comonomer selected from the group consisting of carboxylic acids, carboxylic acid salts, hydroxyalkyl esters of carboxylic acids, and carboxylic acid anhydrides, and (ii) reacting a carboxylic acid polymer and a polyether prepared by polymerizing a C₂-C₄ epoxide, wherein the carboxylic acid polymer and the polyether are reacted under conditions effective to achieve partial cleavage of the polyether and esterification of the polyether and cleavage products thereof by the carboxylic acid polymer.

The preferred polyether polymer or macromonomer preferably comprises ethylene oxide and propylene oxide and has a molecular weight of about 300 grams per mole to about 100,000 grams per mole, more preferably between about 500 grams per mole to about 75,000 grams per mole, and most preferably between about 1,000 grams per mole to about 10,000 grams per mole. All molecular weights are number average molecular weights unless stated otherwise. Preferably, the ratio of propylene oxide (PO) to ethylene oxide (EO) of the polyether polymer or polyether 6 macromonomer is preferably between about 99/1 to about 1/99, more preferably between about 80/20 to about 1/99, and most preferably between about 60/40 to about 1/99 by weight.

Suitable alkylene oxides include ethylene oxide, propylene oxide, butylene oxide, and 7 the like, and mixtures thereof. The polyether macromonomers preferably have hydroxyl functionality from 0 to 5. They can be either linear or branched polymers, homopolymers or copolymers, random or block copolymers, diblock or multipleblock copolymers.

Examples of polyether macromonomers are poly(propylene glycol) acrylates or methacrylates, poly(ethylene glycol) acrylates or methacrylates, poly(ethylene glycol) methyl ether acrylates or methacrylates, acrylates or methacrylates of an oxyethylene and oxypropylene block or random copolymer, poly(propylene glycol) allyl ether, poly(ethylene glycol) allyl ether, poly(propylene glycol) monomaleate, and the like, and mixtures thereof. Preferred polyether macromonomers are poly(propylene glycol) acrylates or methacrylates, poly(ethylene glycol) acrylates or methacrylates, acrylates or methacrylates of an oxyethylene and oxypropylene block and/or random copolymer. More preferred are acrylates or methacrylates of an oxyethylene and oxypropylene block and/or random copolymer.

The ratio of acrylic monomer to polyether macromonomer is determined by many factors within the skilled person's discretion, including the required physical properties of the comb-branched copolymer, the selection of the acrylic monomer, and the properties of the polyether macromonomer. The ratio generally is within the range from 1/99 to 99/1 by weight. The preferred range is from 5/95 to 75/25.

Suitable EO/PO comb polycarboxylates are sold by Lyondell Chemical Company, Houston, Tex., USA, under the name Ethacryl®, for example Ethacryl® D60 and Ethacryl® D40.

### Adjunct Materials

While not essential for the purposes of the present invention, the non-limiting list of adjuncts illustrated hereinafter are suitable for use in the instant compositions and may be desirably incorporated in certain embodiments of the invention, for example to assist or enhance cleaning performance, for treatment of the substrate to be cleaned, or to modify the aesthetics of the cleaning composition as is the case with perfumes, colorants, dyes or the like. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, dispersants, additional enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, solvents and/or pigments. In addition to the disclosure below, suitable examples of such other adjuncts and levels of use are found in U.S. Pat. Nos. 5,576,282, 6,306,812 B1 and 6,326,348 B1 that are incorporated by reference. When one or more adjuncts are present, such one or more adjuncts may be present as detailed below.

Preferred ingredients for the detergent composition of the present invention can be selected from the group consisting of:

(a) lipase for improved greasy soil removal and whiteness maintenance
(b) polycarboxylate dispersants and cellulose ethers and mixtures thereof, preferably at weight ratio of from 1:3 to 10:1 for improved whiteness maintenance;
(c) chelants for improved removal of particulate and/or beverage soils, and whiteness maintenance and especially hydroxyethane-dimethylene-phosphonic acid (HEDP), 2-phosphonobutane-1,2,4-tricarboxylic acid (PBTC) and/or 4,5-dihydroxy-m-benzenedisulfonic acid, disodium salt (Tiron®);
(d) a fluorescent whitening agent for improved whiteness maintenance and cleaning perception especially the following:

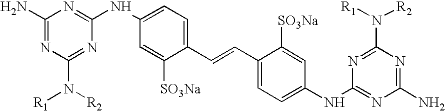

wherein R1 and R2, together with the nitrogen atom linking them, form an unsubstituted or C1-C4 alkyl-substituted morpholino, piperidine or pyrrolidine ring; and
(e) mixtures thereof.

Bleaching Agents—The cleaning compositions of the present invention may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent by weight of the subject cleaning composition. Examples of suitable bleaching agents include:

(1) photobleaches for example sulfonated zinc phthalocyanine sulfonated aluminium phthalocyanines, xanthene dyes and mixtures thereof;
(2) preformed peracids: Suitable preformed peracids include, but are not limited to, compounds selected from the group consisting of percarboxylic acids and salts, percarbonic acids and salts, perimidic acids and salts, peroxymonosulfuric acids and salts, for example, Oxone®, and mixtures thereof. Suitable percarboxylic acids include hydrophobic and hydrophilic peracids having the formula R—(C═O)O—O-M wherein R is an alkyl group, optionally branched, having, when the peracid is hydrophobic, from 6 to 14 carbon atoms, or from 8 to 12 carbon atoms and, when the peracid is hydrophilic, less than 6 carbon atoms or even less than 4 carbon atoms; and M is a counterion, for example, sodium, potassium or hydrogen;
(3) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts are selected from the group consisting of sodium salts of perborate, percarbonate and mixtures thereof. When employed, inorganic perhydrate salts are typically present in amounts of from 0.05 to 40 wt %, or 1 to 30 wt % of the overall composition and are typically incorporated into such compositions as a crystalline solid that may be coated. Suitable coatings include, inorganic salts such as alkali metal silicate, carbonate or borate salts or mixtures thereof, or organic materials such as water-soluble or dispersible polymers, waxes, oils or fatty soaps; and
(4) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS). Suitable bleach activators are also disclosed in WO 98/17767. While any suitable bleach activator may be employed, in one aspect of the invention the subject cleaning composition may comprise NOBS, TAED or mixtures thereof.

When present, the peracid and/or bleach activator is generally present in the composition in an amount of from about 0.1 to about 60 wt %, from about 0.5 to about 40 wt % or even from about 0.6 to about 10 wt % based on the composition. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

Surfactants—The cleaning compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant is typically present at a level of from about 0.1% to about 60%, from about 1% to about 50% or even from about 5% to about 40% by weight of the subject composition.

Builders—The cleaning compositions of the present invention may comprise one or more detergent builders or builder systems. When a builder is used, the subject composition will typically comprise at least about 1%, from about 5% to about 60% or even from about 10% to about 40% builder by weight of the subject composition.

Builders include, but are not limited to, the alkali metal, ammonium and alkanolammonium salts of polyphosphates, alkali metal silicates, alkaline earth and alkali metal carbonates, aluminosilicate builders and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents—Preferably, the detergent composition comprises one or more chelants. Preferably, the detergent composition comprises (by weight of the composition) from 0.01% to 10% chelant, or 0.01 to 5 wt % or 4 wt % or 2 wt %. Preferred chelants are selected from the group consisting of: hydroxyethane-dimethylene-phosphonic acid (HEDP), 2-phosphonobutane-1,2,4-tricarboxylic acid (PBTC), ethylene diamine tetra(methylene phosphonic) acid, diethylene triamine pentacetate, ethylene diamine tetraacetate, diethylene triamine penta(methyl phosphonic) acid, ethylene diamine disuccinic acid, and combinations thereof. A further preferred chelant is an anionically modified catechol. An anionically modified catechol, as used herein, means 1,2-benzenediol having one or two anionic substitutions on the benzene ring. The anionic substitutions may be selected from sulfonate, sulfate, carbonate, phosphonate, phosphate, fluoride, and mixtures thereof. One embodiment of an anionically modified catechol having two sulfate moieties having a sodium cation on the benzene ring is 4,5-dihydroxy-m-benzenedisulfonic acid, disodium salt (Tiron®). Preferably, the anionically modified catechol is essentially free (less than 3%) of catechol (1,2-benzenediol), to avoid skin irritation when present.

Dye Transfer Inhibiting Agents—The cleaning compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Fluorescent whitening agent—The cleaning compositions of the present invention will preferably also contain additional components that may tint articles being cleaned, such as fluorescent whitening agent. Any fluorescent whitening agent suitable for use in a laundry detergent composition may be used in the composition of the present invention. The most commonly used fluorescent whitening agents are those belonging to the classes of diaminostilbene-sulphonic acid derivatives, diarylpyrazoline derivatives and bisphenyl-distyryl derivatives. Examples of the diaminostilbene-sulphonic acid derivative type of fluorescent whitening agents include the sodium salts of:
4,4′-bis-(2-diethanolamino-4-anilino-s-triazin-6-ylamino) stilbene-2,2′-disulphonate,
4,4′-bis-(2,4-dianilino-s-triazin-6-ylamino) stilbene-2.2′-disulphonate,
4,4′-bis-(2-anilino-4(N-methyl-N-2-hydroxy-ethylamino)-s-triazin-6-ylamino) stilbene-2,2′-disulphonate,
4,4′-bis-(4-phenyl-2,1,3-triazol-2-yl)stilbene-2,2′-disulphonate,
4,4′-bis-(2-anilino-4(1-methyl-2-hydroxy-ethylamino)-s-triazin-6-ylamino) stilbene-2,2′-disulphonate and,
2-(stilbyl-4″-naptho-1,2′:4,5)-1,2,3-trizole-2″-sulphonate.

Preferred fluorescent whitening agents are Tinopal® DMS and Tinopal® CBS available from Ciba-Geigy AG, Basel, Switzerland. Tinopal® DMS is the disodium salt of 4,4′-bis-(2-morpholino-4 anilino-s-triazin-6-ylamino) stilbene disulphonate. Tinopal® CBS is the disodium salt of 2,2′-bis-(phenyl-styryl) disulphonate.

Also preferred are fluorescent whitening agents of the structure:

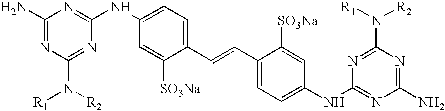

wherein R1 and R2, together with the nitrogen atom linking them, form an unsubstituted or C1-C4 alkyl-substituted morpholino, piperidine or pyrrolidine ring, preferably a morpholino ring (commercially available as Parawhite KX, supplied by Paramount Minerals and Chemicals, Mumbai, India). Other fluorescers suitable for use in the invention include the 1-3-diaryl pyrazolines and the 7-alkylaminocoumarins.

Suitable fluorescent brightener levels include lower levels of from about 0.01, from about 0.05, from about 0.1 or even from about 0.2 wt % to upper levels of 0.5 or even 0.75 wt %.

Polycarboxylate dispersants—The compositions of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

Cellulose ethers—The compositions of the present invention can also contain cellulose ethers, to improve whiteness maintenance and soil repellency of fabrics. Suitable cellulose ethers include, but are not limited to, carboxymethyl cellulose, methylhydroxymethyl cellulose, methyl hydroxypropyl cellulose, methyl cellulose, and mixtures thereof.

Enzymes—In addition to the bacterial alkaline cellulase, the cleaning compositions can comprise one or more other enzymes which provide cleaning performance and/or fabric care benefits. Examples of suitable enzymes include, but are not limited to, hemicellulases, peroxidases, proteases, other cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. Preferably the composition of the present invention will further comprise a lipase. When present in a cleaning composition, the aforementioned additional enzymes may be present at levels from about 0.00001% to about 2%, from about 0.0001% to about 1% or even from about 0.001% to about 0.5% enzyme protein by weight of the composition.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

Catalytic Metal Complexes—Applicants' cleaning compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (WO 05/042532 A1) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRLs include 5,12-diethyl-1,5,8,12-tetraazabicyclo[6.6.2]hexadecane.

Suitable transition metal MRLs are readily prepared by known procedures, such as taught for example in WO 00/32601, and U.S. Pat. No. 6,225,464.

Solvents—Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

### Processes of Making Compositions

The compositions of the present invention can be formulated into any suitable form and prepared by any process chosen by the formulator, non-limiting examples of which are described in Applicants' examples and in U.S. Pat. No. 4,990,280; U.S. 20030087791A1; U.S. 20030087790A1; U.S. 20050003983A1; U.S. 20040048764A1; U.S. Pat. No. 4,762,636; U.S. Pat. No. 6,291,412; U.S. 20050227891A1; EP 1070115A2; U.S. Pat. No. 5,879,584; U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. No. 5,489,392; U.S. Pat. No. 5,486,303 all of which are incorporated herein by reference.

### Method of Use

The present invention includes a method for laundering a fabric. The method comprises the steps of contacting a fabric to be laundered with a said cleaning laundry solution comprising at least one embodiment of Applicants' cleaning composition, cleaning additive or mixture thereof. The fabric may comprise most any fabric capable of being laundered in normal consumer use conditions. The solution preferably has a pH of from about 8 to about 10.5. The compositions may be employed at concentrations of from about 500 ppm to about 15,000 ppm in solution. The water temperatures typically range from about 5° C. to about 90° C. The water to fabric ratio is typically from about 1:1 to about 30:1.

### EXAMPLES

Unless otherwise indicated, materials can be obtained from Aldrich, P.O. Box 2060, Milwaukee, Wis. 53201, USA.

### Examples 1-6

Granular laundry detergent compositions designed for handwashing or top-loading washing machines.

| | 1 | 2 | 3 | 4 | 5 | 6 |
|---|---|---|---|---|---|---|
| | (wt %) | (wt %) | (wt %) | (wt %) | (wt %) | (wt %) |
| Linear alkylbenzenesulfonate | 20 | 22 | 20 | 15 | 20 | 20 |
| C₁₂₋₁₄ Dimethylhydroxyethyl | 0.7 | 1 | 1 | 0.6 | 0.0 | 0.7 |
| ammonium chloride | | | | | | |
| AE3S | 0.9 | 0.0 | 0.9 | 0.0 | 0.0 | 0.9 |
| AE7 | 0.0 | 0.5 | 0.0 | 1 | 3 | 1 |
| Sodium tripolyphosphate | 23 | 30 | 23 | 17 | 12 | 23 |
| Zeolite A | 0.0 | 0.0 | 0.0 | 0.0 | 10 | 0.0 |
| 1.6R Silicate (SiO₂:Na₂O at ratio | 7 | 7 | 7 | 7 | 7 | 7 |
| 1.6:1) | | | | | | |
| Sodium Carbonate | 15 | 14 | 15 | 18 | 15 | 15 |
| Polyacrylate MW 4500 | 1 | 0.0 | 1 | 1 | 1.5 | 1 |
| Carboxy Methyl Cellulose | 1 | 1 | 1 | 1 | 1 | 1 |
| Savinase ® 32.89 mg/g | 0.1 | 0.07 | 0.1 | 0.1 | 0.1 | 0.1 |
| Natalase ® 8.65 mg/g | 0.1 | 0.1 | 0.1 | 0.0 | 0.1 | 0.1 |
| Endoglucanase 15.6 mg/g | 0.03 | 0.07 | 0.3 | 0.1 | 0.07 | 0.4 |
| Fluorescent Brightener 1 | 0.06 | 0.0 | 0.06 | 0.18 | 0.06 | 0.06 |
| Fluorescent Brightener 2 | 0.1 | 0.06 | 0.1 | 0.0 | 0.1 | 0.1 |
| Diethylenetriamine | 0.6 | 0.3 | 0.6 | 0.25 | 0.6 | 0.6 |
| pentaacetic acid | | | | | | |
| MgSO₄ | 1 | 1 | 1 | 0.5 | 1 | 1 |
| Sodium Percarbonate | 0.0 | 5.2 | 0.1 | 0.0 | 0.0 | 0.0 |
| Sodium Perborate Monohydrate | 4.4 | 0.0 | 3.85 | 2.09 | 0.78 | 3.63 |
| NOBS | 1.9 | 0.0 | 1.66 | — | 0.33 | 0.75 |
| TAED | 0.58 | 1.2 | 0.51 | — | 0.015 | 0.28 |
| Sulphonated zinc phthalocyanine | 0.0030 | — | 0.0012 | 0.0030 | 0.0021 | — |
| Ethacryl ® D60 | 0.0 | 0.0 | 0.4 | 0.6 | 0.2 | 0.0 |
| PEG/VA² | 1.0 | 0.2 | 0.0 | 0.0 | 0.5 | 0.6 |
| Sokalan ® HP22 | 0.0 | 0.0 | 0.8 | 0.0 | 0.0 | 0.0 |
| Sulfate/Moisture | Balance | Balance to | Balance to | Balance to | Balance to | Balance to |
| | to 100% | 100% | 100% | 100% | 100% | 100% |

Any of the above compositions is used to launder fabrics at a concentration of 600-1000 ppm in water, with typical median conditions of 2500 ppm, 25° C., and a 25:1 water:cloth ratio.

### Examples 7-10

Granular laundry detergent compositions designed for front-loading automatic washing machines.

| | 7 | 8 | 9 | 10 |
|---|---|---|---|---|
| | (wt %) | (wt %) | (wt %) | (wt %) |
| Linear alkylbenzenesulfonate | 8 | 7.1 | 7 | 6.5 |
| AE3S | 0 | 4.8 | 0 | 5.2 |
| Alkylsulfate | 1 | 0 | 1 | 0 |
| AE7 | 2.2 | 0 | 3.2 | 0 |
| C₁₀₋₁₂ Dimethyl hydroxyethylammonium | 0.75 | 0.94 | 0.98 | 0.98 |
| chloride | | | | |
| Crystalline layered silicate (δ-Na₂Si₂O₅) | 4.1 | 0 | 4.8 | 0 |
| Zeolite A | 20 | 0 | 17 | 0 |
| Citric Acid | 3 | 5 | 3 | 4 |
| Sodium Carbonate | 15 | 20 | 14 | 20 |
| Silicate 2R (SiO₂:Na₂O at ratio 2:1) | 0.08 | 0 | 0.11 | 0 |
| Soil release agent | 0.75 | 0.72 | 0.71 | 0.72 |
| Acrylic Acid/Maleic Acid Copolymer | 1.1 | 3.7 | 1.0 | 3.7 |
| Carboxymethylcellulose | 0.15 | 1.4 | 0.2 | 1.4 |
| Protease (56.00 mg active/g) | 0.37 | 0.4 | 0.4 | 0.4 |
| Termamyl ® (21.55 mg active/g) | 0.3 | 0.3 | 0.3 | 0.3 |
| Endoglucanase 15.6 mg/g | 0.05 | 0.15 | 0.1 | 0.5 |
| Natalase ® (8.65 mg active/g) | 0.1 | 0.14 | 0.14 | 0.3 |
| TAED | 3.6 | 4.0 | 3.6 | 4.0 |
| Percarbonate | 13 | 13.2 | 13 | 13.2 |
| Na salt of Ethylenediamine-N,N′- | 0.2 | 0.2 | 0.2 | 0.2 |
| disuccinic acid, (S,S) isomer (EDDS) | | | | |
| Hydroxyethane di phosphonate (HEDP) | 0.2 | 0.2 | 0.2 | 0.2 |
| MgSO₄ | 0.42 | 0.42 | 0.42 | 0.42 |
| Perfume | 0.5 | 0.6 | 0.5 | 0.6 |
| Suds suppressor agglomerate | 0.05 | 0.1 | 0.05 | 0.1 |
| Soap | 0.45 | 0.45 | 0.45 | 0.45 |
| Sodium sulfate | 22 | 33 | 24 | 30 |
| Sulphonated zinc phthalocyanine (active) | 0.0007 | 0.0012 | 0.0007 | — |
| PEG/VA² | 0.2 | 0.4 | 0.0 | 0.4 |
| Ethacryl ® D60 | 0.4 | 0.0 | 0.3 | 0.0 |
| Water & Miscellaneous | Balance to 100% | Balance | Balance | Balance |
| | | to 100% | to 100% | to 100% |

Any of the above compositions is used to launder fabrics at a concentration of 10,000 ppm in water, 20-90° C., and a 5:1 water:cloth ratio. The typical pH is about 10.

### Examples 11-16

### Heavy Duty Liquid Laundry Detergent Compositions

| | 11 | 12 | 13 | 14 | 15 | 16 |
|---|---|---|---|---|---|---|
| | (wt %) | (wt %) | (wt %) | (wt %) | (wt %) | (wt %)7 |
| AES C₁₂₋₁₅ alkyl ethoxy | 11 | 10 | 4 | 6.32 | 6.0 | 8.2 |
| (1.8) sulfate | | | | | | |
| Linear alkyl benzene | 4 | 0 | 8 | 3.3 | 4.0 | 3.0 |
| sulfonate | | | | | | |
| HSAS | 0 | 5.1 | 3 | 0 | 2 | 0 |
| Sodium formate | 1.6 | 0.09 | 1.2 | 0.04 | 1.6 | 1.2 |
| Sodium hydroxide | 2.3 | 3.8 | 1.7 | 1.9 | 2.3 | 1.7 |
| Monoethanolamine | 1.4 | 1.490 | 1.0 | 0.7 | 1.35 | 1.0 |
| Diethylene glycol | 5.5 | 0.0 | 4.1 | 0.0 | 5.500 | 4.1 |
| Nonionic | 0.4 | 0.6 | 0.3 | 0.3 | 2 | 0.3 |
| Chelant | 0.15 | 0.15 | 0.11 | 0.07 | 0.15 | 0.11 |
| Citric Acid | 2.5 | 3.96 | 1.88 | 1.98 | 2.5 | 1.88 |
| C₁₂₋₁₄ dimethyl Amine | 0.3 | 0.73 | 0.23 | 0.37 | 0.3 | 0.225 |
| Oxide | | | | | | |
| C₁₂₋₁₈ Fatty Acid | 0.8 | 1.9 | 0.6 | 0.99 | 0.8 | 0.6 |
| Borax | 1.43 | 1.5 | 1.1 | 0.75 | 1.43 | 1.07 |
| Ethanol | 1.54 | 1.77 | 1.15 | 0.89 | 1.54 | 1.15 |
| Ethoxylated (EO₁₅) | 0.3 | 0.33 | 0.23 | 0.17 | 0.0 | 0.0 |
| tetraethylene | | | | | | |
| pentaimine¹ | | | | | | |
| 1,2-Propanediol | 0.0 | 6.6 | 0.0 | 3.3 | 0.0 | 0.0 |
| Liquanase ®* | 36.4 | 36.4 | 27.3 | 18.2 | 36.4 | 27.3 |
| Mannaway ® * | 1.1 | 1.1 | 0.8 | 0.6 | 1.1 | 0.8 |
| Natalase ®* | 7.3 | 7.3 | 5.5 | 3.7 | 7.3 | 5.5 |
| Endoglucanase | 10 | 3.2 | 0.5 | 3.2 | 2.4 | 3.2 |
| 15.6 mg/g | | | | | | |
| Ethacryl ® D60 | 1.0 | 0.0 | 0.0 | 0.0 | 0.7 | 0.2 |
| PEG/VA² | 0.0 | 0.2 | 0.5 | 0.7 | 0.0 | 0.4 |
| Sokalan ® HP22 | 0.0 | 0.6 | 0.0 | 0.0 | 0.0 | 0.0 |

| | |
|---|---|
| Water, perfume, dyes & | Balance to 100% |
| other components | |

### Raw Materials and Notes for Composition Examples 1-16

Linear alkylbenzenesulfonate having an average aliphatic carbon chain length C₁₁-C₁₂ supplied by Stepan, Northfield, Ill., USA
C₁₂₋₁₄ Dimethylhydroxyethyl ammonium chloride, supplied by Clariant GmbH, Sulzbach, Germany
AE3S is C₁₂₋₁₅ alkyl ethoxy (3) sulfate supplied by Stepan, Northfield, Ill., USA
AE7 is C₁₂₋₁₅ alcohol ethoxylate, with an average degree of ethoxylation of 7, supplied by Huntsman, Salt Lake City, Utah, USA
Sodium tripolyphosphate is supplied by Rhodia, Paris, France
Zeolite A was supplied by Industrial Zeolite (UK) Ltd, Grays, Essex, UK
1.6R Silicate was supplied by Koma, Nestemica, Czech Republic
Sodium Carbonate was supplied by Solvay, Houston, Tex., USA
Polyacrylate MW 4500 is supplied by BASF, Ludwigshafen, Germany
Carboxy Methyl Cellulose is Finnfix® BDA supplied by CPKelco, Arnhem, Netherlands
Savinase®, Natalase®, Termamyl®, Mannaway® and Liquanase®* supplied by Novozymes, Bagsvaerd, Denmark
Endoglucanase: Celluclean® 5T, supplied by Novozymes, Bagsvaerd, Denmark

### Fluorescent Brightener 1 is Tinopal® AMS, Fluorescent Brightener 2 is Tinopal® CBS-X,

Sulphonated zinc phthalocyanine and Direct Violet 9 was Pergasol® Violet BN-Z all supplied by Ciba Specialty Chemicals, Basel, Switzerland
Diethylenetriamine pentacetic acid was supplied by Dow Chemical, Midland, Mich., USA
Sodium percarbonate supplied by Solvay, Houston, Tex., USA
Sodium perborate was supplied by Degussa, Hanau, Germany
NOBS is sodium nonanoyloxybenzenesulfonate, supplied by Eastman, Batesville, Ark., USA
TAED is tetraacetylethylenediamine, supplied under the Peractive® brand name by Clariant GmbH, Sulzbach, Germany
Soil release agent is Repel-o-tex® PF, supplied by Rhodia, Paris, France
Acrylic Acid/Maleic Acid Copolymer is molecular weight 70,000 and acrylate:maleate ratio 70:30, supplied by BASF, Ludwigshafen, Germany
Protease described in U.S. Pat. No. 6,312,936B1 and supplied by Genencor International, Palo Alto, Calif., USA
Na salt of Ethylenediamine-N,N′-disuccinic acid, (S,S) isomer (EDDS) was supplied by Octel, Ellesmere Port, UK
Hydroxyethane di phosphonate (HEDP) was supplied by Dow Chemical, Midland, Mich., USA
Suds suppressor agglomerate was supplied by Dow Corning, Midland, Mich., USA
HSAS is mid-branched alkyl sulfate as disclosed in U.S. Pat. No. 6,020,303 and U.S. Pat. No. 6,060,443
C₁₂₋₁₄ dimethyl Amine Oxide was supplied by Procter & Gamble Chemicals, Cincinnati, Ohio, USA
Nonionic is preferably a C₁₂-C₁₃ ethoxylate, preferably with an average degree of ethoxylation of 9.
Sokalan® HP22 was supplied by BASF AG, Ludwigshafen, Germany * Numbers quoted in mg enzyme/100 g¹ as described in U.S. Pat. No. 4,597,898² PEG/VA is polyethylene glycol backbone having a mol average molecular weight of 6,000 g/mol grafted w/60% weight vinyl acetate at 70° C.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising a bacterial alkaline enzyme exhibiting endo-beta-1,4-glucanase activity and a ethoxylated polymer comprising:
(a) a random graft copolymer comprising a hydrophilic backbone comprising monomers comprising unsaturated C₁₋₆ acids, ethers, alcohols, aldehydes, ketones or esters, sugar units, alkoxy units, maleic anhydride and saturated polyalcohols such as glycerol, and mixtures thereof, and hydrophobic side chains comprising a C₄₋₂₅ alkyl group, polypropylene; polybutylene, a vinyl ester of a saturated monocarboxylic acid containing from about 1 to about 6 carbon atoms; a C₁₋₆ alkyl ester of acrylic or methacrylic acid; and a mixture thereof;
(b) a modified polyethyleneimine polymer wherein the modified polyethyleneimine polymer comprises a polyethyleneimine backbone of about 300 to about 10000 weight average molecular weight; the modification of the polyethyleneimine backbone is:
(1) one or two alkoxylation modifications per nitrogen atom in the polyethyleneimine backbone, the alkoxylation modification comprising the replacement of a hydrogen atom by a polyalkoxylene chain having an average of about 1 to about 40 alkoxy moieties per modification, wherein the terminal alkoxy moiety of the alkoxylation modification is capped with hydrogen, a C₁-C₄ alkyl or mixtures thereof;
(2) a substitution of one C₁-C₄ alkyl moiety and one or two alkoxylation modifications per nitrogen atom in the polyethyleneimine backbone, the alkoxylation modification comprising the replacement of a hydrogen atom by a polyalkoxylene chain having an average of about 1 to about 40 alkoxy moieties per modification wherein the terminal alkoxy moiety is capped with hydrogen, a C₁-C₄ alkyl or mixtures thereof; or
(3) a combination thereof;
(c) a modified polyaminoamide comprising formula (I) 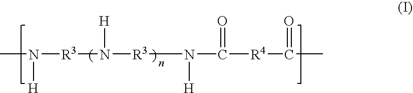
wherein n of formula (I) is an integer from 1 to 500; R³ formula (I) is selected from an C₂-C₈ alkanediyl, preferably 1,2-ethanediyl or 1,3-propane diyl; R⁴ formula (I) is selected from a chemical bond, C₁-C₂₀-alkanediyl, C₁-C₂₀-alkanediyl comprising 1 to 6 heteroatoms selected from the group consisting of oxygen, sulfur, and nitrogen, C₁-C₂₀-alkanediyl comprising 1 to 6 heteroatoms selected from the group consisting of oxygen, sulfur, and nitrogen further comprising one or more hydroxyl groups, a substituted or unsubstituted divalent aromatic radical, and mixtures thereof; wherein formula (I) comprises secondary amino groups of the polymer backbone, the amino hydrogens are selectively substituted in the modified polyaminoamide such that the modified polyaminoamide comprises partial quaternization of the secondary amino groups by selectively substituting at least one amino hydrogen with at least one alkoxy moiety of formula (II):
—(CH₂—CR¹R²—O—)ₚA (II)
wherein A of formula (II) is selected from a hydrogen or an acidic group, the acidic group being selected from —B¹—PO(OH)₂, —B¹—S(O)₂OH and —B²—COOH; such that B¹ of formula (II) is a single bond or C₁-C₆-alkanediyl; and B² of formula (II) is C₁-C₆-alkanediyl; R¹ of formula (II) is independently selected from hydrogen, C₁-C₁₂-alkyl, C₂-C₈-alkenyl, C₆-C₁₆-aryl or C₆-C₁₆-aryl-C₁-C₄-alkyl; R² of formula (II) is independently selected from hydrogen or methyl; and p of formula (II) is an integer comprising a number average of at least 10;
With the remainder of the amino hydrogens of the secondary amino groups being selected from the group comprising electron pairs, hydrogen, C₁-C₆-alkyl, C₆-C₁₆-aryl-C₁-C₄-alkyl and formula (III) Alk-O-A, wherein:
A of formula (III) is hydrogen or an acidic group, the acidic group being selected from —B¹—PO(OH)₂, —B¹—S(O)₂OH and —B²—COOH; such that B¹ of formula (III) is selected from a single bond or a C₁-C₆-alkanediyl; and B² of formula (III) is selected from a C₁-C₆-alkanediyl, and Alk of formula (III) is C₂-C₆-alkane-1,2-diyl;
the secondary amino groups of formula (I) are further selected to comprise at least one alkylating moiety of formula (IV):
-RX (IV)
Wherein R of formula (IV) comprises C₁-C₆-alkyl, C₆-C₁₆-aryl-C₁-C₄-alkyl, formula (III) Alk-O-A, formula (II) —(CH₂—CR¹R²—O—)ₚA; and mixtures thereof; and
X of formula (IV) is a leaving group comprising a halogen, an alkyl-halogen, a sulfate, an alkylsulfonate, an arylsulfonate, an alkyl sulfate, and mixtures thereof;
(d) a non-hydrophobically modified, acrylic/polyether comb-branched copolymer wherein the polyether portion comprises moieties derived from at least 2 constituents selected from the group consisting of ethylene oxide, propylene oxide and butylene oxide; and
(e) mixtures thereof.

2. A composition according to claim 1 wherein enzyme is a bacterial polypeptide endogenous to a member of the genus Bacillus.

3. A composition according to claim 1 wherein the enzyme is a polypeptide comprising: (i) at least one family 17 carbohydrate binding module; (ii) at least one family 28 carbohydrate binding module; and (iii) a mixture thereof.

4. A composition according to claim 1 wherein the enzyme comprises a polypeptide endogenous to one of the following Bacillus species comprising: AA349 (DSM 12648), KSM S237, 1139, KSM 64, KSM N131, KSM 635 (FERM BP 1485), KSM 534 (FERM BP 1508), KSM 53 (FERM BP 1509), KSM 577 (FERM BP 1510), KSM 521 (FERM BP 1507), KSM 580 (FERM BP 1511), KSM 588 (FERM BP 1513), KSM 597 (FERM BP 1514), KSM 522 (FERM BP 1512), KSM 3445 (FERM BP 1506), KSM 425 (FERM BP 1505), and mixtures thereof.

5. A composition according to claim 1 wherein the enzyme comprises:
(i) the endoglucanase having the amino acid sequence of positions 1 to position 773 of SEQ ID NO:1;
(ii) an endoglucanase having a sequence of at least 90% identity to the amino acid sequence of position 1 to position 773 of SEQ ID NO: 1; or a fragment thereof has endo-beta-1,4-glucanase activity, when identity is determined by GAP provided in the GCG program using a GAP creation penalty of 3.0 and GAP extension penalty of 0.1; and
(iii) mixtures thereof.

6. A composition according to claim 1 wherein the enzyme is an alkaline endoglucanase variant obtained by substituting the amino acid residue of a cellulase having an amino acid sequence exhibiting at least 90% identity with the amino acid sequence represented by SEQ. ID NO:2 at (a) position 10, (b) position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564, and (p) position 608 in SEQ ID NO:2 and at a position corresponding thereto with another amino acid residue.

7. A composition according to claim 5 wherein the enzyme is characterised by at least one of the following substitutions:
(a) at position 10: glutamine, alanine, proline or methionine;
(b) at position 16: asparagine or arginine;
(c) at position 22: proline;
(d) at position 33: histidine;
(e) at position 39: alanine, threonine or tyrosine;
(f) at position 76: histidine, methionine, valine, threonine or alanine;
(g) at position 109: isoleucine, leucine, serine or valine;
(h) at position 242: alanine, phenylalanine, valine, serine, aspartic acid, glutamic acid, leucine, isoleucine, tyrosine, threonine, methionine or glycine;
(i) at position 263: isoleucine, leucine, proline or valine;
(j) at position 308: alanine, serine, glycine or valine;
(k) at position 462: threonine, leucine, phenylalanine or arginine;
(l) at position 466: leucine, alanine or serine;
(m) at position 468: alanine, aspartic acid, glycine or lysine;
(n) at position 552: methionine;
(o) at position 564: valine, threonine or leucine; and
(p) at position 608: isoleucine or arginine.

8. A composition according to claim 6 wherein the enzyme comprising an endoglucanase variant comprising Egl-237, Egl-1139, Egl-64, Egl-N131b, and mixtures thereof.

9. A composition according to claim 1 wherein the enzyme is an alkaline cellulase K having the following physical and chemical properties:
(1) Activity: Having a Cx enzymatic activity of acting on carboxymethyl cellulose along with a weak C₁ enzymatic activity and a weak beta-glucoxidase activity;
(2) Specificity on Substrates: Acting on carboxymethyl cellulose, crystalline cellulose, Avicell, cellobiose, and p-nitrophenyl cellobioside;
(3) Having a working pH in the range of 4 to 12;
(4) Having stable pH values of 4.5 to 10.5 and 6.8 to 10 when allowed to stand at 40° C. for 10 minutes and 30 minutes, respectively;
(5) Working in a wide temperature range of from 10 to 65° C.;
(6) Influences of chelating agents: The activity not impeded with ethylenediamine tetraacetic acid, ethyleneglycol-bis-(β-aminoethylether) N,N,N′,N″-tetraacetic acid, N,N-bis(carboxymethyl)glycine (nitrilotriacetic acid), sodium tripolyphosphate and zeolite;
(7) Influences of surface active agents: Undergoing little inhibition of activity by means of surface active agents such as sodium linear alkylbenzenesulfonates, sodium alkylsulfates, sodium polyoxyethylene alkylsulfates, sodium alphaolefinsulfonates, sodium alpha-sulfonated aliphatic acid esters, sodium alkylsulfonates, polyoxyethylene secondary alkyl ethers, fatty acid salts, and dimethyldialkylammonium chloride;
(8) Having a strong resistance to proteinases; and
(9) Molecular weight: Having a maximum peak at 180,000±10,000.

10. A composition according to claim 9 wherein the alkaline cellulase K is obtained by isolation from a culture product of Bacillus sp KSM-635.

11. A composition according to claim 1 wherein the enzyme comprises:
Alkaline Cellulase K-534 from KSM 534, FERM BP 1508,
Alkaline Cellulase K-539 from KSM 539, FERM BP 1509,
Alkaline Cellulase K-577 from KSM 577, FERM BP 1510,
Alkaline Cellulase K-521 from KSM 521, FERM BP 1507,
Alkaline Cellulase K-580 from KSM 580, FERM BP 1511,
Alkaline Cellulase K-588 from KSM 588, FERM BP 1513,
Alkaline Cellulase K-597 from KSM 597, FERM BP 1514,
Alkaline Cellulase K-522 from KSM 522, FERM BP 1512,
Alkaline Cellulase E-II from KSM 522, FERM BP 1512,
Alkaline Cellulase E-III from KSM 522, FERM BP 1512.
Alkaline Cellulase K-344 from KSM 344, FERM BP 1506,
Alkaline Cellulase K-425 from KSM 425, FERM BP 1505, and mixtures thereof.

12. A composition according to claim 1 wherein the enzyme comprises an endoglucanase derived from Bacillus species KSM-N.

13. A composition according to claim 1 wherein the bacterial alkaline enzyme exhibiting endo-beta-1,4-glucanase activity is comprised at a level of from about 0.00005% to about 0.15% by weight of pure enzyme.

14. A composition according to claim 1 wherein said ethoxylated polymer is comprised at a level of about 0.1% to about 10% by weight.

15. A composition according to claim 1 wherein the ethoxylated polymer (a) is a random graft copolymer having a hydrophilic backbone comprising polyethylene glycol of molecular weight from 3,000 to 25,000, and from 40% to 70% by weight hydrophobic side chains formed by polymerising at least one monomer comprising:
(i) a vinyl ester of a saturated monocarboxylic acid containing from 1 to 6 carbon atoms;
(ii) a C₁₋₆ alkyl ester of acrylic or methacrylic acid; and
(iii) mixtures thereof.

16. A composition according to claim 15 wherein the polymer (a) is further characterised as a random graft copolymer having a hydrophilic backbone comprising polyethylene glycol of molecular weight from 4,000 to 15,000, and from 50% to 65% by weight hydrophobic side chains formed by polymerising at least one monomer comprising vinyl acetate; butyl acrylate; and mixtures thereof.

17. A composition according to claim 15 wherein the polymer (a) is further characterised as a random graft copolymer having a hydrophilic backbone comprising polyethylene glycol of molecular weight from 4,000 to 15,000, and from 50% to 65% by weight hydrophobic side chains formed by polymerising at least one monomer comprising vinyl acetate, where the temperature of grafting is between 60-80° C.

18. A composition according to claim 1 wherein the ethoxylated polymer (b) is a modified polyethyleneimine polymer comprising a polyethyleneimine backbone of 400 to 7500 weight average molecular weight; the modification of the polyethyleneimine backbone comprising the replacement of a hydrogen atom by a polyalkoxylene chain comprising ethoxy/propoxy block moieties wherein the propoxy moiety block is the terminal alkoxy moiety block, having from 5 to 15 ethoxy moieties and from 1 to 16 propoxy moieties; wherein the terminal alkoxy moiety blocks are capped with hydrogen, a C₁-C₄ alkyl or mixtures thereof.

19. A composition according to claim 18 wherein the ethoxylated polymer (b) is of formula II: 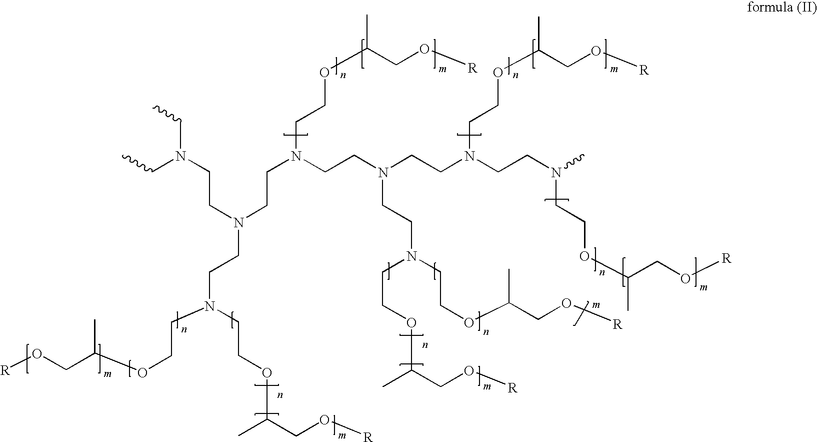
wherein the polyethyleneimine backbone of formula (II) has a weight average molecular weight of 600 or 5000, n of formula (II) has an average of 10, m of formula (II) has an average of 7 and R of formula (II) comprises hydrogen, a C₁-C₄ alkyl and mixtures thereof; and the degree of permanent quaternization of formula (II) is from 0% to 22% of the polyethyleneimine backbone nitrogen atoms.

20. A composition according to claim 1 wherein the ethoxylated polymer (c) is a modified polyaminoamide of formula (X): 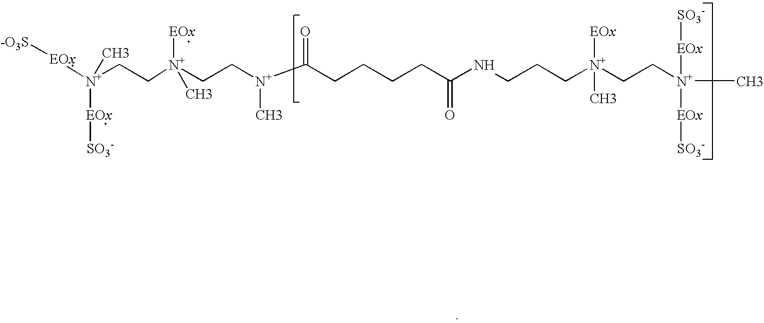
wherein x of formula (X) is from 21 to 50; EO in formula (X) represents ethoxy moieties; wherein the ratio of dicarboxylic acid:polyalkylenepolyamines in formula (X) comprises 4:5 or 35:36.

21. A composition according to claim 1 wherein ehtoxylated polymer (d) is a non-hydrophobically modified, acrylic/polyether comb-branched polymer having a number average molecular weight of 1,000 grams per mole to 100,000 grams per mole and a mole ratio of acrylic monomer units to polyether units from 1:1 to 20:1.

22. The composition according to claim 1 further comprising a detergent ingredient comprises:
(a) lipase;
(b) polycarboxylates, carboxymethyl cellulose and mixtures thereof;
(c) chelants comprising: hydroxyethane-dimethylene-phosphonic acid, 2-phosphonobutane-1,2,4-tricarboxylic acid, r 4,5-dihydroxy-m-benzenedisulfonic acid, disodium salt and mixtures thereof;
(d) a fluorescent whitening agent having the formula: 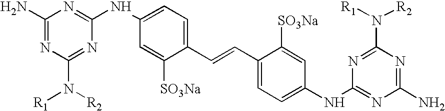
wherein R₁ and R₂, together with the nitrogen atom linking them, form an unsubstituted or C₁-C₄ alkyl-substituted morpholino, piperidine or pyrrolidine ring; and
(e) mixtures thereof.

23. A process of cleaning and/or treating a surface or fabric comprising the steps of:
(a) optionally washing and/or rinsing said surface or fabric;
(b) contacting said surface or fabric with the composition according to claim 1; and
(c) optionally washing and/or rinsing said surface or fabric.
